(19) United States
(12) Patent Application Publication
(10) Pub. No.: US 2016/0322153 A1
(43) Pub. Date: Nov. 3, 2016

(54) METHOD OF MANUFACTURING ELECTRONIC COMPONENT, AND ELECTRONIC COMPONENT

(71) Applicant: TOKO, INC., Tsurugashima-shi (JP)

(72) Inventors: Takao KAWACHI, Saitama (JP); Yoshiharu SATO, Saitama (JP); Takahiro OGAWA, Saitama (JP)

(21) Appl. No.: 15/107,818

(22) PCT Filed: Nov. 17, 2014
(86) PCT No.: PCT/JP2014/080399

§ 371 Date: Jun. 23, 2016

(30) Foreign Application Priority Data
Dec. 27, 2013 (JP) 2013-271627

(51) Int. Cl. H01F 27/255; H01F 27/29; H01F 41/12; H01F 27/28; H01F 41/061; H01F 41/02

(52) U.S. Cl. CPC H01F 27/255; H01F 41/061; H01F 41/0246; H01F 41/12; H01F 27/2823; H01F 27/292

(57) ABSTRACT

A method of manufacturing an electronic component includes: a coil forming step of forming a winding coil by a wire-shaped conductor; a coil fixing step of providing a coil fixation body that fixes the winding coil by an insulation resin; a magnetic body attaching step of providing a magnetic body such that the coil fixation body as a whole is covered by a composite magnetic material in which magnetic particles and a resin are mixed; a pressurizing step of pressurizing and molding an entirety; and a hardening step of hardening the magnetic body.

### TECHNICAL FIELD

The present invention relates to a method of manufacturing an electronic component used as a power inductor or the like of a power supply circuit, and such an electronic component.

### BACKGROUND ART

A power inductor used for a power supply circuit is required to be small, low-loss, and capable of responding to high current. In order to respond to these demands, there have been developed inductors employing, as a magnetic material of such inductors, a composite magnetic material such as metal magnetic powder having high saturation magnetic flux density (e.g., Japanese Patent No. 4714779). One advantage of the inductors employing a composite magnetic material is high direct-current superimposed allowable current. However, in order to reduce a size of the component while maintaining self-inductance L, it is necessary that a part made of the composite magnetic material to be thin. In this case, a power inductor having a structure in which a coil is embedded in a composite magnetic material is manufactured one by one, and accordingly poses a problem that separation of the composite magnetic material easily occurs at a portion where the composite magnetic material is thin, especially on a side of the component, resulting in a poor yield ratio and difficulty in size reduction.

One method of avoiding the problem that separation of the composite magnetic material easily occurs at a portion where the composite magnetic material is thin is to perform molding at a high pressure. However, with the conventional winding structure, a problem that a shape of winding changes in high-pressure molding arises.

Moreover, there is a method of previously providing a shape such as a core shape or a bobbin shape, or a temporary molding in a form of a tablet as disclosed in Japanese Patent No. 4714779, and perform molding combining the temporary molding with a conductor. However, in a case of small-sized inductors, it is difficult to provide a complicated shape such as a core shape or a bobbin shape, or a temporary molding, or the like.

### SUMMARY OF INVENTION

An object of one or more embodiments according to the present invention is to provide a method of manufacturing an electronic component with high self-inductance L, high allowable current, and that can be easily made small at an excellent yield ratio, as well as to provide such an electronic component.

The present invention addresses the above problems based on the following solutions, which are described with references made to numbers of embodiments according to the present invention in order to facilitate understanding. However, the solutions are not limited to these embodiments.

### Embodiment 1

One or more embodiments according to the present invention provides a method of manufacturing an electronic component, the method including: a coil forming step of forming a coil by a wire-shaped conductor; a coil fixing step of providing a coil fixation body that fixes the coil by an insulation resin; a magnetic body attaching step of providing a magnetic body such that the coil fixation body as a whole is covered by a composite magnetic material in which magnetic particles and a resin are mixed; a pressurizing step of pressurizing and molding an entirety; and a hardening step of hardening the magnetic body.

### Embodiment 2

One or more embodiments according to the present invention provides the method of manufacturing an electronic component according to Embodiment 1, wherein the magnetic body attaching step includes: a press fitting step of embedding the coil fixation body into a plate-shaped composite magnetic material in a state in which the plate-shaped composite magnetic material is softened, the plate-shaped composite magnetic material being the composite magnetic material formed in a plated shape; and a covering step of covering a part of the coil fixation body with a different plate-shaped composite magnetic material that is softened, the part of the coil fixation body being a part remaining uncovered in the press fitting step.

### Embodiment 3

One or more embodiments according to the present invention provides the method of manufacturing an electronic component according to Embodiment 2, wherein at least the press fitting step and the steps following the press fitting step are performed to more than one coil fixation body at the same time using the plate-shaped composite magnetic material having a size on which a plurality of coil fixation bodies are placeable.

### Embodiment 4

One or more embodiments according to the present invention provides the method of manufacturing an electronic component according to Embodiment 1, wherein the pressurizing step and the hardening step are performed at the same time.

### Embodiment 5

One or more embodiments according to the present invention provides an electronic component including: a coil fixation body that fixes a coil by an insulation resin, the coil being formed by a wire-shaped conductor; and a magnetic body formed of a composite magnetic material so as to cover the coil fixation body excluding a terminal, the composite magnetic material being a material that is hardened and in which magnetic particles and a resin are mixed.

### Embodiment 6

One or more embodiments according to the present invention provides the electronic component according to Embodiment 5, wherein the magnetic body is formed by embedding the coil fixation body into a plate-shaped composite magnetic material in a state in which the plate-shaped composite magnetic material is softened, and then hardening the plate-shaped composite magnetic material, the plate-shaped composite magnetic material being a composite magnetic material that is formed in a plate shape.

### Embodiment 7

One or more embodiments according to the present invention provides the electronic component according to Embodiment 5 or 6, manufactured based on the method of manufacturing an electronic component defined in one of Embodiments 1 to 4.

According to the present invention, the following advantageous effects may be provided.

(1) In one or more embodiments according to the present invention, the method of manufacturing an electronic component includes: a coil forming step of forming a coil by a wire-shaped conductor; a coil fixing step of providing a coil fixation body that fixes the coil by an insulation resin; a magnetic body attaching step of providing a magnetic body such that the coil fixation body as a whole is covered by a composite magnetic material in which magnetic particles and a resin are mixed; a pressurizing step of pressurizing and molding an entirety; and a hardening step of hardening the magnetic body. Therefore, according to one or more embodiments of the present invention, as the coil fixation body may maintain its shape, it is possible to make the magnetic body rigid through the pressurizing step and the hardening step. Thus, according to one or more embodiments of the present invention, it is possible to manufacture an electronic component at an excellent yield ratio and to be small in size without sacrificing self-inductance L and allowable current as compared to the conventional method.

(2) In one or more embodiments according to the present invention, the magnetic body attaching step includes: a press fitting step of embedding the coil fixation body into a plate-shaped composite magnetic material in a state in which the plate-shaped composite magnetic material is softened, the plate-shaped composite magnetic material being the composite magnetic material formed in a plated shape; and a covering step of covering a part of the coil fixation body with a different plate-shaped composite magnetic material that is softened, the part of the coil fixation body being a part remaining uncovered in the press fitting step. Therefore, according to one or more embodiments of the present invention, it is possible to easily perform the magnetic body attaching step using a composite magnetic material having a simple plated shape. Further, as a plate-shaped composite magnetic material is used, it is possible to manufacture a plurality of electronic components side by side at the same time.

(3) In one or more embodiments according to the present invention, at least the press fitting step and the steps following the press fitting step are performed to more than one coil fixation body at the same time using the plate-shaped composite magnetic material having a size on which a plurality of coil fixation bodies are placeable. Thus, according to one or more embodiments of the present invention, it is possible to manufacture an electronic component efficiently.

(4) In one or more embodiments according to the present invention, the pressurizing step and the hardening step are performed at the same time. Thus, according to one or more embodiments of the present invention, it is possible to manufacture an electronic component efficiently, and to make a magnetic body more rigid.

(5) In one or more embodiments according to the present invention, the electronic component includes: a coil fixation body that fixes a coil by an insulation resin, the coil being formed by a wire-shaped conductor; and a magnetic body formed of a composite magnetic material so as to cover the coil fixation body excluding a terminal, the composite magnetic material being a material that is hardened and in which magnetic particles and a resin are mixed. Therefore, according to one or more embodiments of the present invention, it is possible to easily make the electronic component small without sacrificing self-inductance L and allowable current, and thus to improve a yield ratio.

(6) In one or more embodiments according to the present invention, the magnetic body is formed by embedding the coil fixation body into a plate-shaped composite magnetic material in a state in which the plate-shaped composite magnetic material is softened, and then hardening the plate-shaped composite magnetic material, the plate-shaped composite magnetic material being a composite magnetic material that is formed in a plate shape. Thus, according to one or more embodiments of the present invention, it is possible to easily mold the magnetic body using a composite magnetic material having a simple plated shape.

### BRIEF DESCRIPTION OF DRAWINGS

FIG. 1 is a perspective view illustrating a first embodiment of an electronic component 10 according to the present invention.

FIG. 2 is a longitudinal sectional view of the electronic component 10 taken along line Z-Z in FIG. 1.

FIGS. 3A and 3B show perspective views illustrating a configuration of a coil fixation body 12.

FIGS. 4A and 4B show views illustrating a manufacturing process of the electronic component 10 according to the first embodiment.

FIGS. 5C, 5D, and 5E show views illustrating the manufacturing process of the electronic component 10 according to the first embodiment.

FIGS. 6A, 6B, and 6C show views illustrating a manufacturing process of the electronic component 10 according to a second embodiment.

FIGS. 7D, 7E, and 7F show views illustrating the manufacturing process of the electronic component 10 according to the second embodiment.

### DESCRIPTION OF EMBODIMENTS

Hereinafter, best modes for carrying out the present invention will be described with reference to the drawings.

### First Embodiment

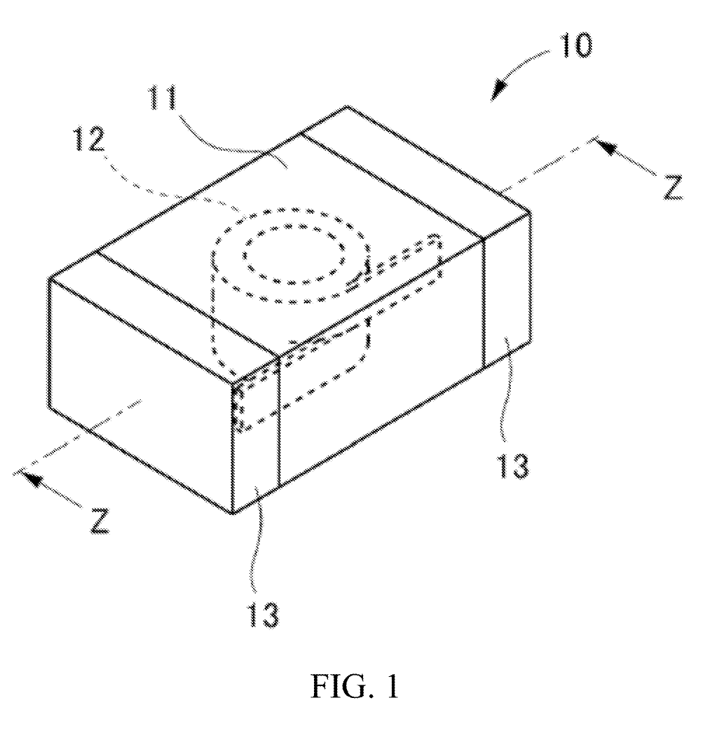

FIG. 1 is a perspective view illustrating a first embodiment of an electronic component 10 according to the present invention.

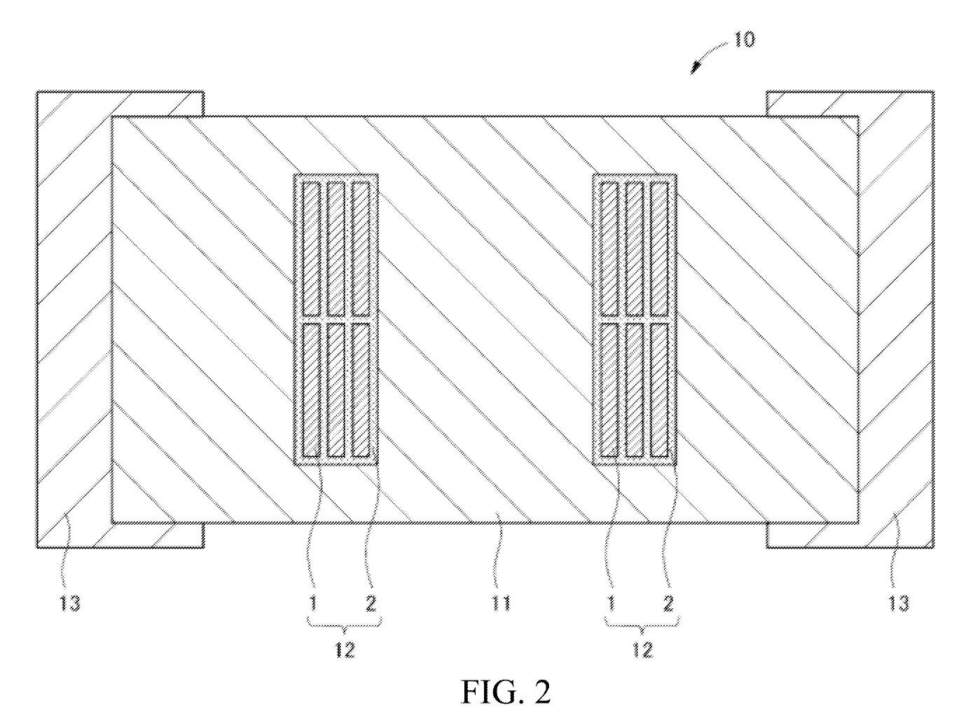

FIG. 2 is a longitudinal sectional view of the electronic component 10 taken along line Z-Z in FIG. 1.

In order to facilitate understanding, terms such as top and bottom are used in the following description. However, these terms only refer to directions in the drawings, and shall not limit a configuration of the present invention.

It should be noted that the drawings including FIG. 1 are schematic views, and sizes and shapes of components are shown exaggeratingly as needed, in order to facilitate understanding.

Further, while references are made to specific values, shapes, materials, and the like in the following description, these specifics may be altered as needed.

The electronic component 10 is an inductor including a magnetic body 11, a coil fixation body 12, and external terminals 13.

The magnetic body 11 is formed by hardening a composite magnetic material in which magnetic particles and a resin are mixed. As an example of the composite magnetic material, a material in which ferrous metal magnetic powder and an epoxy resin are mixed may be used. The magnetic body 11 is provided so as to fill a space where the coil fixation body 12 is not present without any gap.

The coil fixation body 12 is formed by fixing a winding coil 1 by an insulation resin portion 2.

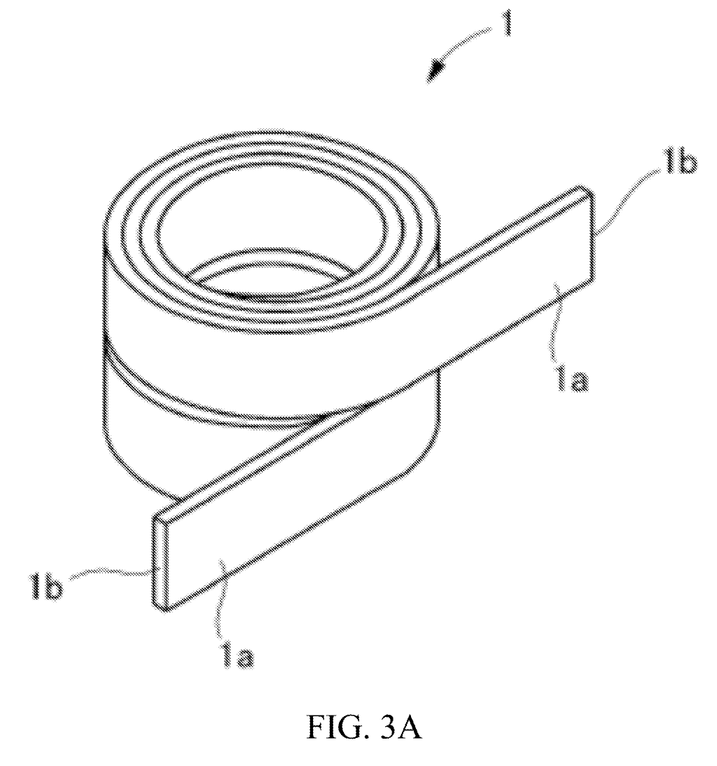

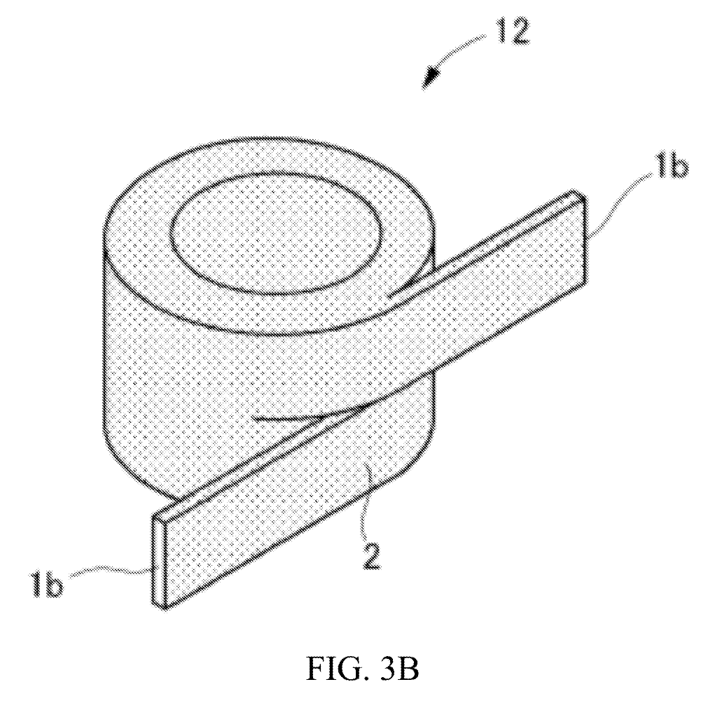

FIGS. 3A and 3B show perspective views illustrating a configuration of the coil fixation body 12. FIG. 3A shows the winding coil 1 before being fixed by the insulation resin portion 2, and FIG. 3B shows the coil fixation body 12 after the winding coil 1 is fixed by the insulation resin portion 2.

The winding coil 1 is formed by winding a conductive wire having a rectangular cross-section, for example, into a two-tiered coil in an α-wound manner (outside-to-outside manner). Further, side-end surfaces 1a of the winding coil 1 extend respectively from the same side of the winding coil 1 to both ends of the electronic component 10.

The insulation resin portion 2 is made of a resin having insulation properties such as a polyimide resin, an epoxy resin, a phenolic resin, or an acrylic resin, and covers an entire surface except for a part of the winding coil 1. In addition to an insulating function, the insulation resin portion 2 has a function of fixing the winding coil 1 to maintain a form as the coil fixation body 12. In FIG. 3B, a portion indicated by fine dots is a portion to which the insulation resin portion 12 is attached. The insulation resin portion 2 is formed by a method such as dipping the winding coil 1 in a liquid resin bath. Here, at tip-end surfaces 1b of the side-end surfaces 1a of the winding coil 1, the insulation resin portion 2 is not formed in order to provide conduction with the external terminals 13.

Each of the external terminals 13 is a terminal made of a conductive material such as silver or copper, so as to be conducted to either of the tip-end surfaces 1b of the winding coil 1 of the electronic component 10.

Next, a method of manufacturing the electronic component 10 according to this embodiment will be described.

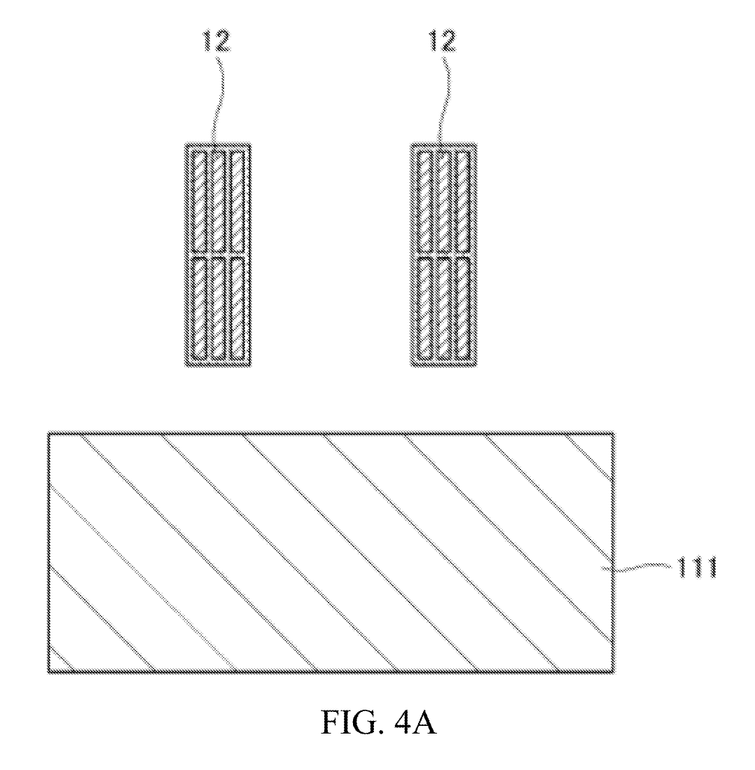

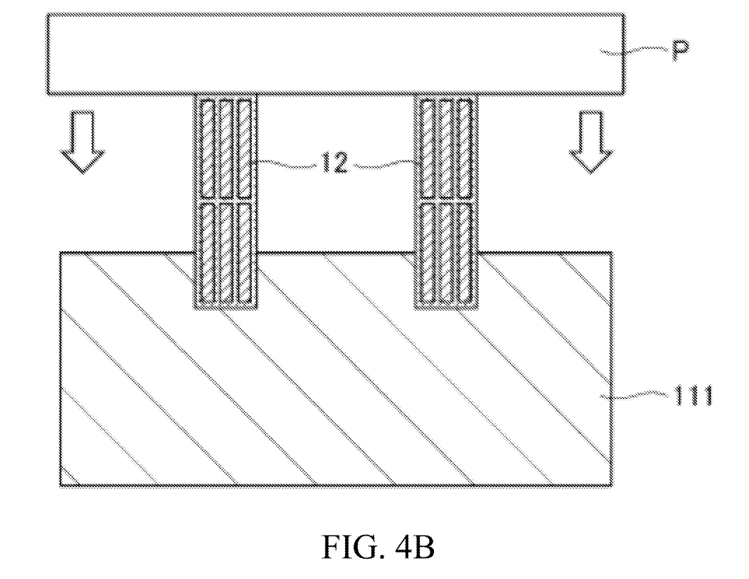

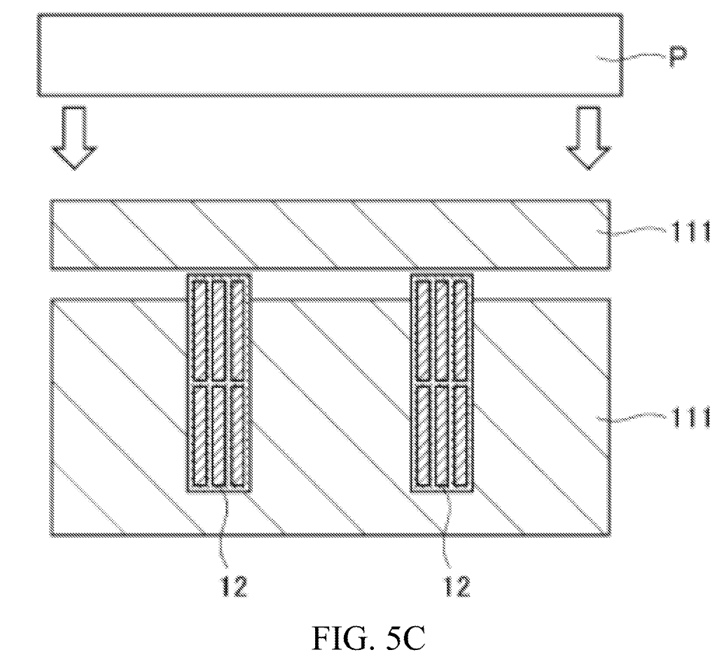

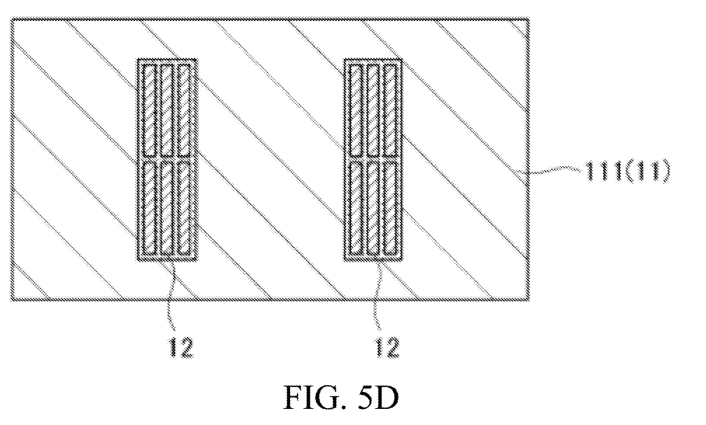

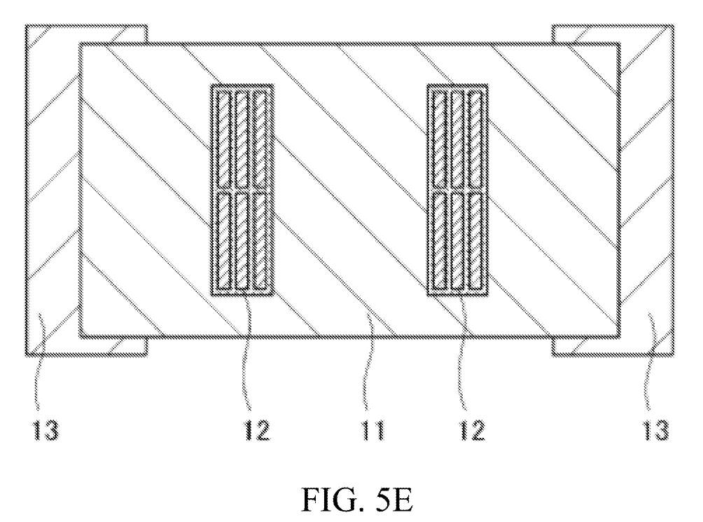

FIGS. 4A, 4B, 5C, 5D, and 5E show views illustrating a manufacturing process of the electronic component 10 according to the first embodiment.

### (First Step: Coil Forming Step and Coil Fixing Step)

First, as illustrated in FIG. 3A, the winding coil 1 is formed by a rectangular wire (coil forming step), and the insulation resin portion 2 is attached and fixed to the winding coil 1 thus formed to provide the coil fixation body 12 (coil fixing step).

### (Second Step: Magnetic Body Attaching Step 1 (Press Fitting Step))

Next, a plate-shaped composite magnetic material 111 which is a material for the magnetic body 11 is prepared, and the coil fixation body 12 is set at a predetermined position (FIG. 4A).

In this state, the plate-shaped composite magnetic material 111 is heated up to a temperature from 70 degrees C. to 120 degrees C. Then, as illustrated in FIG. 4B, in a state in which the plate-shaped composite magnetic material 111 is softened, the coil fixation body 12 is pressed against the plate-shaped composite magnetic material 111 using a press mold P, and the coil fixation body 12 is embedded into the plate-shaped composite magnetic material 111.

### (Third Step: Magnetic Body Attaching Step 2 (Covering Step))

Next, as illustrated in FIG. 5C, a different plate-shaped composite magnetic material 111 that is softened is further placed so as to cover the coil fixation body 12 that remains uncovered in the second step and extending. Then, the different plate-shaped composite magnetic material 111 is pressed using the press mold P. With this, an upper surface of the coil fixation body 12 is also covered by the plate-shaped composite magnetic materials 111, and a state shown in FIG. 5D is realized.

### (Fourth Step: Pressurizing Step and Hardening Step)

Next, while maintaining a temperature from 150 degrees C. to 200 degrees C., the plate-shaped composite magnetic materials 111 as a whole in the state shown in FIG. 5D are pressurized (pressed) and molded (pressurizing step), and the magnetic body 11 (composite magnetic material) is hardened (hardening step). As the magnetic body 11 is made rigid through the pressurizing step and the hardening step, it is possible to manufacture the electronic component 10 without causing separation and at an excellent yield ratio even if the magnetic body 11 is made thin to have a distance from the coil fixation body 12 to an outer circumference is from 100 μm to 200 μm, for example. Thus, according to the manufacturing method of this embodiment, the electronic component 10 may be made small in size. Here, pressurization and hardening may be performed separately, or the magnetic body 11 may be hardened at the same time when the plate-shaped composite magnetic materials 111 as a whole are pressurized and molded while maintaining temperature from 150 degrees C. to 200 degrees C.

### (Fifth Step: External Electrode Forming Step)

Finally, as illustrated in FIG. 5E, the external terminals 13 are formed on the both ends to complete the electronic component 10 by dipping the component in a conductive paste such as silver or copper, or by sputtering or plating a conductive material such as silver or copper. Here, a cutting step for cutting the magnetic body 11 into a predetermined outer shape may be provided as needed between the fourth step and the fifth step. The external terminals 13 may be formed into a variety of shapes. For example, the external terminals 13 may be formed in an L shape across a bottom surface and an end surface of the magnetic body 11, or may be formed only on the bottom surface of the magnetic body 11.

It should be noted that at least the press fitting step and the steps following the press fitting step among the above steps are performed to more than one coil fixation body 12 at the same time using the plate-shaped composite magnetic material 111 of a size on which a plurality of coil fixation bodies 12 may be placed. With this, it is possible to manufacture the electronic component 10 efficiently.

As described above, according to the first embodiment, the electronic component 10 is manufactured by first forming the coil fixation body 12, and then press fitting the coil fixation body 12 into the plate-shaped composite magnetic material 111 to pressurize and harden the composite magnetic material. As the coil fixation body 12 is formed by fixing the winding coil 1 by the insulation resin portion 2, the winding coil 1 may not be deformed in such a manner that the winding coil 1 is flexed at a portion between a first tier and a second tier due to pressurization or that a conductive wire constituting the winding coil 1 is collapsed. Therefore, the electronic component 10 of the first embodiment may be molded while being pressurized at a high pressure as compared to the case in which the winding coil is not fixed by the insulation resin portion. Further, by molding while being pressurized at a high pressure like this, it is possible to manufacture the electronic component 10 at an excellent yield ratio even if the magnetic body 11 is made thin. Specifically, according to the first embodiment, the electronic component 10 as a whole may be made small in size by making the magnetic body 11 thin without downsizing the coil itself.

Thus, according to the first embodiment, it is possible to manufacture the electronic component 10 at an excellent yield ratio and to facilitate downsizing of the electronic component 10, even when self-inductance L and allowable current of the electronic component 10 are maintained to be high.

Further, according to the first embodiment, by placing the plurality of the coil fixation bodies 12 on the plate-shaped composite magnetic material 111, it is possible to manufacture a plurality of electronic components 10 at the same time, and thus to manufacture the electronic component 10 efficiently.

### Second Embodiment

The electronic component 10 according to a second embodiment has a configuration similar to that of the electronic component 10 of the first embodiment other than that its manufacturing method is partially different. Therefore, components having the same functions as those in the first embodiment described above are denoted by the same reference numerals, and repetitive descriptions shall be omitted if not necessary.

In the following, a method of manufacturing the electronic component 10 according to the second embodiment will be described.

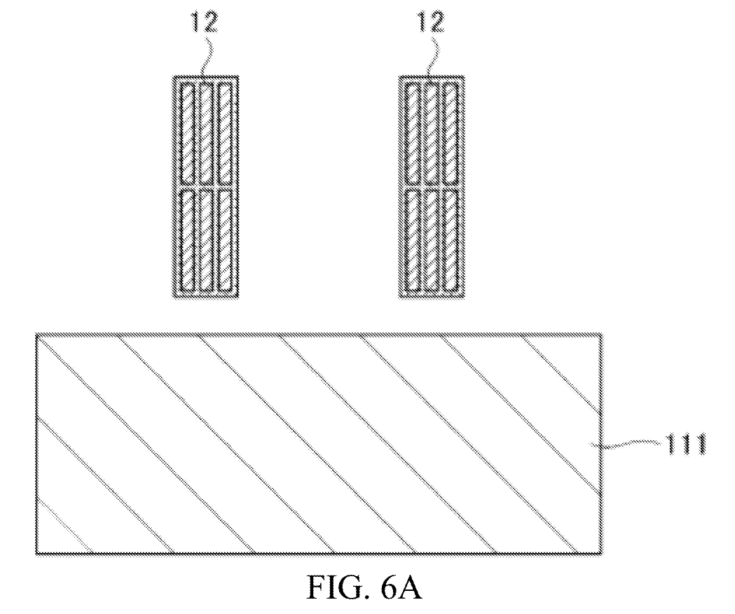

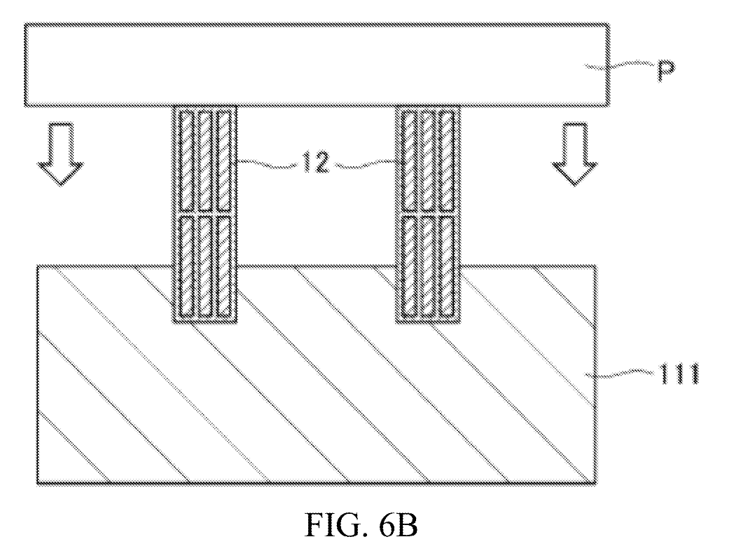

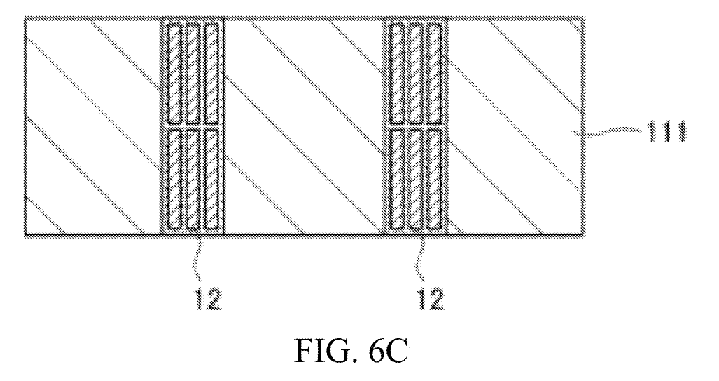

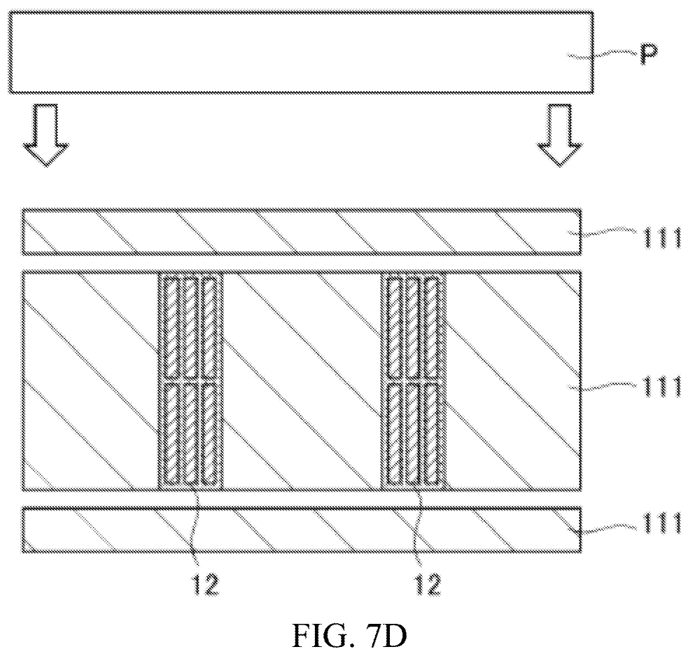

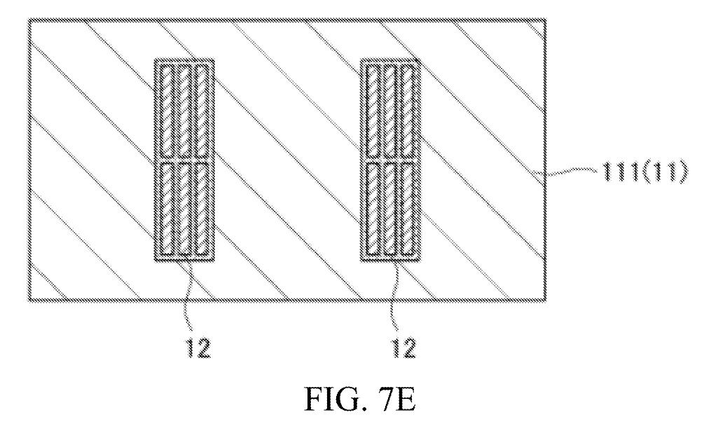

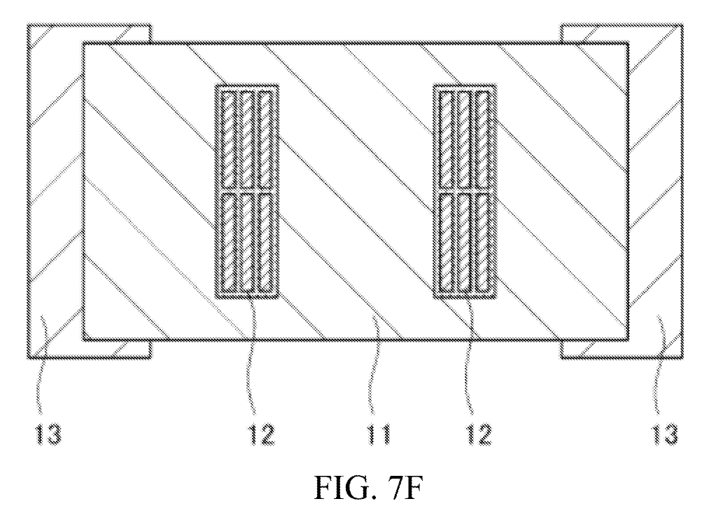

FIGS. 6A, 6B, 6C, 7D, 7E, and 7F show views illustrating a manufacturing process of the electronic component 10 according to the second embodiment.

### (First Step: Coil Forming Step and Coil Fixing Step)

First, similarly to the first embodiment, as illustrated in FIG. 6A, the winding coil 1 is formed by a rectangular wire (coil forming step), and the insulation resin portion 2 is attached and fixed to the winding coil 1 thus formed to provide the coil fixation body 12 (coil fixing step).

Further, the plate-shaped composite magnetic material 111 which is a material for the magnetic body 11 is prepared. A thickness of the plate-shaped composite magnetic material 111 prepared here is substantially the same as a height of the coil fixation body 12.

### (Second Step: Magnetic Body Attaching Step 1 (Press Fitting Step))

Next, the plate-shaped composite magnetic material 111 is heated up to a temperature from 70 degrees C. to 120 degrees C. Then, as illustrated in FIG. 6B, in a state in which the plate-shaped composite magnetic material 111 is softened, the coil fixation body 12 is pressed against the plate-shaped composite magnetic material 111 using a press mold P, and the coil fixation body 12 is embedded into the plate-shaped composite magnetic material 111.

When embedding of the coil is completed, as illustrated in FIG. 6C, only an amount of the composite magnetic material is attached to upper and bottom ends of the coil fixation body 12, or the upper end and the bottom end of the coil fixation body 12 are partially exposed.

### (Third Step: Magnetic Body Attaching Step 2 (Covering Step))

Next, as illustrated in FIG. 7D, two other plate-shaped composite magnetic materials 111 that are softened are placed respectively over the top and the bottom of the coil fixation body 12 that remain uncovered in the second step. Then, the two plate-shaped composite magnetic materials 111 are pressed using the press mold P so as to cover the top and the bottom of the coil fixation body 12. With this, both an upper surface and a bottom surface of the coil fixation body 12 are also covered by the plate-shaped composite magnetic materials 111, and a state shown in FIG. 7E is realized. According to the second embodiment, by placing the plate-shaped composite magnetic materials 111 both on the top side and the bottom side, it is possible to more accurately control the thickness of the magnetic body 11 (composite magnetic material) above and below the coil fixation body 12.

### (Fourth Step: Pressurizing Step and Hardening Step)

Next, while maintaining a temperature from 150 degrees C. to 200 degrees C., the plate-shaped composite magnetic materials 111 as a whole in the state shown in FIG. 7E are pressurized (pressed) and molded (pressurizing step), and the magnetic body 11 (composite magnetic material) is hardened (hardening step). As the magnetic body 11 is made rigid through the pressurizing step and the hardening step, it is possible to manufacture the electronic component 10 without causing separation and at an excellent yield ratio even if the magnetic body 11 is made thin to have a distance from the coil fixation body 12 to an outer circumference is from 100 μm to 200 μm, for example. Further, according to the second embodiment, as the thickness of the magnetic body 11 on the top and the bottom may be accurately controlled, it is possible to reduce production tolerances, and thus to form the magnetic body 11 to be as thin as possible. Thus, according to the manufacturing method of this embodiment, the electronic component 10 may be made small in size. Here, pressurization and hardening may be performed separately, or at the same time.

### (Fifth Step: External Electrode Forming Step)

Finally, as illustrated in FIG. 7F, the external terminals 13 are formed on the both ends to complete the electronic component 10 by dipping the component in a conductive paste such as silver or copper, or by sputtering or plating a conductive material such as silver or copper. Here, a cutting step for cutting the magnetic body 11 into a predetermined outer shape may be provided as needed between the fourth step and the fifth step. The external terminals 13 may be formed into a variety of shapes. For example, the external terminals 13 may be formed in an L shape across a bottom surface and an end surface of the magnetic body 11, or may be formed only on the bottom surface of the magnetic body 11.

Similarly to the first embodiment, at least the press fitting step and the steps following the press fitting step among the above steps are performed to more than one coil fixation body 12 at the same time using the plate-shaped composite magnetic material 111 of a size on which a plurality of coil fixation bodies 12 may be placed. With this, it is possible to manufacture the electronic component 10 efficiently.

As described above, according to the second embodiment, the coil fixation body 12 is covered by the two plate-shaped composite magnetic materials 111 so as to be sandwiched from both sides in the covering step. Therefore, it is possible to more accurately control vertical dimensions, and to manufacture the electronic component 10 at an excellent yield ratio and to be small in size.

### Variations

The present invention may not be limited to the embodiments described above, and may be modified and altered in various ways, which are also included within the scope of the present invention.

(1) In the above embodiments, the winding coil 1 is described to be in the α-wound manner as one example. However, the present invention is not limited to such an example, and the winding coil may be wound in an ordinary manner in which both ends are respectively pulled outside and inside.

(2) In the above embodiments, the winding coil 1 is described to have a two-tiered structure as one example. However, the present invention is not limited to such an example, and the winding coil may have a four-tiered structure, or may be in any configuration.

(3) In the above embodiments, the winding coil 1 may be formed by winding a conductive wire having a round cross-section.

(4) In the above embodiments, the insulation resin portion may be formed by spraying a resin to the winding coil, or attaching a resin to the winding coil by sputtering.

It should be noted that the embodiments and the variations described above may be applied in combination as appropriate, but detailed descriptions shall be omitted. Finally, the present invention may not be limited to the embodiments described above.

### REFERENCE SIGNS LIST

1: winding coil
1a: side-end surface
1b: tip-end surface
2: insulation resin portion
10: electronic component
11: magnetic body
12: coil fixation body
13: external terminal
111: plate-shaped composite magnetic material
P: press mold

1. A method of manufacturing an electronic component, the method comprising:
a coil forming step of forming a coil by a wire-shaped conductor;
a coil fixing step of providing a coil fixation body that fixes the coil by an insulation resin;
a magnetic body attaching step of providing a magnetic body such that the coil fixation body as a whole is covered by a composite magnetic material in which magnetic particles and a resin are mixed;
a pressurizing step of pressurizing and molding an entirety; and
a hardening step of hardening the magnetic body.

2. The method of manufacturing an electronic component according to claim 1, wherein
the magnetic body attaching step includes:
a press fitting step of embedding the coil fixation body into a plate-shaped composite magnetic material in a state in which the plate-shaped composite magnetic material is softened, the plate-shaped composite magnetic material being the composite magnetic material formed in a plated shape; and
a covering step of covering a part of the coil fixation body with a different plate-shaped composite magnetic material that is softened, the part of the coil fixation body being a part remaining uncovered in the press fitting step.

3. The method of manufacturing an electronic component according to claim 2, wherein
at least the press fitting step and the steps following the press fitting step are performed to more than one coil fixation body at the same time using the plate-shaped composite magnetic material having a size on which a plurality of coil fixation bodies are placeable.

4. The method of manufacturing an electronic component according to claim 1, wherein
the pressurizing step and the hardening step are performed at the same time.

5. An electronic component comprising:
a coil fixation body that fixes a coil by an insulation resin, the coil being formed by a wire-shaped conductor; and
a magnetic body formed of a composite magnetic material so as to cover the coil fixation body excluding a terminal, the composite magnetic material being a material that is hardened and in which magnetic particles and a resin are mixed.

6. The electronic component according to claim 5, wherein
the magnetic body is formed by embedding the coil fixation body into a plate-shaped composite magnetic material in a state in which the plate-shaped composite magnetic material is softened, and then hardening the plate-shaped composite magnetic material, the plate-shaped composite magnetic material being a composite magnetic material that is formed in a plate shape.

7. The electronic component according to claim 5,
wherein the electronic component is manufactured based on a method comprising:
a coil forming step of forming the coil by the wire-shaped conductor;
a coil fixing step of providing the coil fixation body that fixes the coil by an insulation resin;
a magnetic body attaching step of providing a magnetic body such that the coil fixation body as a whole is covered by a composite magnetic material in which magnetic particles and a resin are mixed;
a pressurizing step of pressurizing and molding an entirety; and
a hardening step of hardening the magnetic body.

8. The electronic component according to claim 6,
wherein the electronic component is manufactured based on a method comprising:
a coil forming step of forming the coil by the wire-shaped conductor;
a coil fixing step of providing the coil fixation body that fixes the coil by an insulation resin;
a magnetic body attaching step of providing a magnetic body such that the coil fixation body as a whole is covered by a composite magnetic material in which magnetic particles and a resin are mixed;
a pressurizing step of pressurizing and molding an entirety; and
a hardening step of hardening the magnetic body.
